(19) United States
(12) Patent Application Publication
(10) Pub. No.: US 2015/0211278 A1
(43) Pub. Date: Jul. 30, 2015

(54) DOOR CLOSER WITH TRI-LOBE PINION

(71) Applicant: Stanley Security Solutions, Inc., Indianapolis, IN (US)

(72) Inventors: David D. Moyer, Coatesville, PA (US); Chad A. Hickman, Rensselaer, IN (US)

(73) Assignee: Stanley Security Solutions, Inc., Indianapolis, IN (US)

(21) Appl. No.: 14/163,450

(22) Filed: Jan. 24, 2014

(51) Int. Cl. E05F 3/08

(52) U.S. Cl. CPC E05F 3/08

(57) ABSTRACT

A door closer assembly is configured to controllably close a door and to accommodate several door closer assembly installation configurations. The door closer assembly includes a housing that carries a pinion having a pinion shaft with a tri-lobe end portion. A closer arm having a tri-lobe opening is configured to receive the tri-lobe end portion of the pinion shaft in driving engagement. The tri-lobe end portion of the pinion shaft and the corresponding tri-lobe opening in the closer arm cooperate to limit the number of orientations that the closer arm may be connected to the pinion shaft.

### CROSS-REFERENCE TO RELATED APPLICATIONS

This application claims priority to U.S. patent application Ser. No. 29/468,980 entitled “PINION” filed Oct. 4, 2013, which is incorporated herein by reference.

### BACKGROUND OF THE INVENTION

1. Field of the Invention

The present invention relates to door hardware, and, more particularly, to a door closer.

2. Description of the Related Art

A door closer is used to aid in the closing of a door while preventing the door from closing too rapidly, i.e., slamming shut.

A typical door closer assembly includes a door closer and a door closer arm assembly. The door closer includes the mechanical and hydraulic components for providing energy and damping during door closure. The door closer arm assembly is configured as an articulated arm having two arm segments, namely: a main closer arm and a secondary closer arm. One end of each of the main closer arm and the secondary closer arm are joined by a pivot mechanism. The mounting end of the main closer arm is connectable to a rotatable shaft of the door closer. The secondary closer arm may be in the form of an adjustable-length rod.

The door closer is configured to accommodate a plurality of mounting types, such as for example, a regular (standard) mount, a parallel mount, and a top jamb mount. In a regular (standard) mount or parallel mount, the door closer housing is mounted to the door and the mounting end of the secondary closer arm is pivotally connected to the door frame. In a top jamb mount, the door closer is mounted to the door frame and the mounting end of the secondary arm is pivotally connected to the door.

In each of the regular mount and top jamb mount configurations, the main closer arm is generally perpendicular (90 degrees±15 degrees) to the door surface when the door is in the closed position. In the parallel mount, the main closer arm of the closer arm is generally parallel (0 degrees±15 degrees) to the door surface when the door is in the closed position. Also, in that parallel mount, the main closer arm extends from the closer unit in a direction away from the hinge end of the door.

In order for the door closer to accommodate each of the mounting types, the door closer is configured such that the main closer arm of the door closer arm assembly may be received by the rotatable shaft of the door closer in a plurality of orientations. However, there is only one correct main closer arm/shaft orientation for the regular and top jamb mounts for a right-hand door, only one correct main closer arm/shaft orientation for the regular and top jamb mounts for a left-hand door, only one correct main closer arm/shaft orientation for the parallel arm mount for a right-hand door, and only one correct main closer arm/shaft orientation for the parallel arm mount for a left-hand door. Thus, in order to be universal, the door closer must accommodate each of the correct main closer arm/shaft orientations.

In one commercially available door closer, for example, the rotatable shaft has a hexagonal head and the mounting end of the main closer arm has a hexagonal opening for receiving the hexagonal head of the shaft of the door closer. As such, the hex configuration accommodates each of the correct main closer arm/shaft orientations described above. However, the hex configuration has six possible orientations of the main closer arm relative to the rotatable shaft of the door closer, of which only one orientation is correct for a particular mounting type, i.e., there are five incorrect orientations and one correct orientation.

Another commercially available door closer has a rotatable shaft having a square head and the mounting end of the main closer arm has an eight-pointed star opening for receiving the square head in eight different orientations, of which there are seven incorrect orientations and one correct orientation, for a particular mounting type.

Accordingly, a door closer installer may have difficulty in identifying the correct orientation for a main closer arm relative to the rotatable shaft of the door closer during the door closer installation. Adding to this orientation determination difficulty is the need to rotate the rotatable door closer shaft with the main closer arm during installation to join the main closer arm with the secondary closer arm, and in turn to provide a pre-load to the door closer.

What is needed in the art is a door closer that can accommodate each of the correct shaft/arm configurations of the various mounting types, while reducing the number of incorrect shaft/arm mounting orientations for a particular mounting type.

### SUMMARY OF THE INVENTION

The present invention provides a door closer that accommodates the correct shaft/arm configurations of various closer mounting types, while reducing the number of incorrect shaft/arm mounting orientations for a particular mounting type.

The invention, in one form thereof, is directed to a door closer assembly that includes a housing having a first enclosed end, a second enclosed end, a longitudinal bore and a pinion bore. The longitudinal bore defines a longitudinal axis and the longitudinal bore is configured to extend between the first enclosed end and the second enclosed end. The pinion bore defines a rotational axis that is perpendicular to the longitudinal axis. A piston is configured for insertion into the longitudinal bore. The piston has a proximal end, a distal end, and a body extending between the proximal end and the distal end. The piston has an elongate slotted opening extending through the body in a direction parallel to the pinion bore. The elongate slotted opening has a wall face configured as a rack gear having a plurality of longitudinally spaced rack teeth. A pinion has an elongate pinion shaft and a pinion gear. The elongate pinion shaft includes a tri-lobe end portion. The pinion gear extends radially outwardly from the elongate pinion shaft. The pinion gear has a number of pinion teeth defined as a positive integer multiple of three, wherein three corresponds to the number of lobes of the tri-lobe end portion. The pinion is positioned in the pinion bore of the housing to extend through the elongate slotted opening of the piston along the rotational axis. The pinion gear is drivably engaged with the rack gear of the piston. The tri-lobe end portion extends outwardly from the housing along the rotational axis in a first direction. A closer arm having a tri-lobe opening is configured to receive the tri-lobe end portion in driving engagement.

The invention, in another form thereof, is directed to a door closer assembly that includes a door closer arm assembly and a door closer. The door closer arm assembly is configured as an articulating arm having a main closer arm and a secondary closer arm. The main closer arm is pivotally joined to the secondary closer arm. The main closer arm has a first mounting end and the secondary closer arm has a second mounting end. The first mounting end of the main closer arm has a tri-lobe opening. The door closer includes a housing having a first enclosed end, a second enclosed end, a longitudinal bore and a pinion bore. The longitudinal bore defines a longitudinal axis and the longitudinal bore is configured to extend between the first enclosed end and the second enclosed end. The pinion bore defines a rotational axis that is perpendicular to the longitudinal axis. A piston has a proximal end, a distal end, and a body extending between the proximal end and the distal end. The piston is configured for insertion into the longitudinal bore to divide the longitudinal bore into a spring chamber and a reservoir chamber, with the distal end being positioned adjacent to the reservoir chamber. The piston has a elongate slotted opening extending through the body of the piston in a direction parallel to the pinion bore. The elongate slotted opening has two opposed longitudinal wall faces, with one wall face of the two opposed longitudinal wall faces being configured as a rack gear having a plurality of longitudinally spaced rack teeth. At least one damped hydraulic passage extends within the housing between the reservoir chamber and the spring chamber. A spring mechanism is interposed between the first enclosed end of the housing and the proximal end of the piston. A pinion has an elongate pinion shaft and a pinion gear. The elongate pinion shaft has a first tri-lobe end portion, a second tri-lobe end portion, and an intermediate portion between the first tri-lobe end portion and the second tri-lobe end portion. The pinion gear extends radially outwardly from the intermediate portion between the first tri-lobe end portion and the second tri-lobe end portion. The pinion gear has a number of pinion teeth defined as a positive integer multiple of three, wherein three corresponds to the number of lobes of each of the first tri-lobe end portion and the second tri-lobe end portion. The pinion is positioned in the pinion bore of the housing to extend through the elongate slotted opening of the piston along the rotational axis. The pinion gear is drivably engaged with the rack gear of the piston. The first tri-lobe end portion extends outwardly from the housing along the rotational axis in a first direction, and the second tri-lobe end portion extends outwardly from the housing along the rotational axis in a second direction opposite the first direction. The tri-lobe opening of the main closer arm is configured to receive one of the first tri-lobe end portion and the second tri-lobe end portion in driving engagement.

The invention, in another form thereof, is directed to a pinion for a door closer configured to accommodate both a regular mount and a parallel mount. The pinion includes an elongate pinion shaft having a rotational axis, a first tri-lobe end portion, a second tri-lobe end portion, and an intermediate portion between the first tri-lobe end portion and the second tri-lobe end portion. Each of the first tri-lobe end portion and the second tri-lobe end portion has a first lobe, a second lobe and a third lobe. Each of the first lobe, the second lobe and the third lobe has a convex arcuate extent that is circumferentially centered on a respective radius of three radii that extend from the rotational axis. Each adjacent pair of lobes of the first lobe, the second lobe and the third lobe is separated by a respective concave arcuate recess of three concave recesses. A pinion gear extends radially outwardly from the elongate pinion shaft. The pinion gear has a number of pinion teeth defined as a positive integer multiple of three, wherein three corresponds to the number of lobes of each of the first tri-lobe end portion and the second tri-lobe end portion.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a door closer assembly of the present invention in a regular (standard) mount on a left-hand door;

FIG. 2 is a perspective view of a door closer assembly of the present invention in a regular (standard) mount on a right-hand door;

FIG. 3 is a perspective view of a door closer assembly of the present invention in a parallel mount on a right-hand door (also called a left-hand reverse door);

FIG. 4 is a perspective of a door closer assembly of the present invention in a parallel mount on a left-hand door (also called a right-hand reverse door);

FIG. 5 is a perspective of a door closer assembly of the present invention, showing the door closer with the door closer arm assembly removed;

FIG. 6 is a top view of the door closer of FIG. 5;

FIG. 7 is a section view of the housing of the door closer of FIG. 5, taken along line 7-7 of FIG. 6, and exposing internal components of the door closer;

FIG. 8 is an enlarged perspective view of the piston and pinion arrangement of the door closer of FIGS. 5-7;

FIG. 9 is a further enlarged top view of the piston and pinion arrangement of FIG. 8;

FIG. 10 is a further enlarged perspective view of the pinion of FIG. 8;

FIG. 11 is side view of the pinion of FIG. 10; and

FIG. 12 is an end view of the pinion of FIGS. 8 and 10, wherein the end view is that of the opposite end that is not shown in full in FIGS. 8 and 10.

Corresponding reference characters indicate corresponding parts throughout the several views. The exemplifications set out herein illustrate one embodiment of the invention, in one form, and such exemplifications are not to be construed as limiting the scope of the invention in any manner.

### DETAILED DESCRIPTION OF THE INVENTION

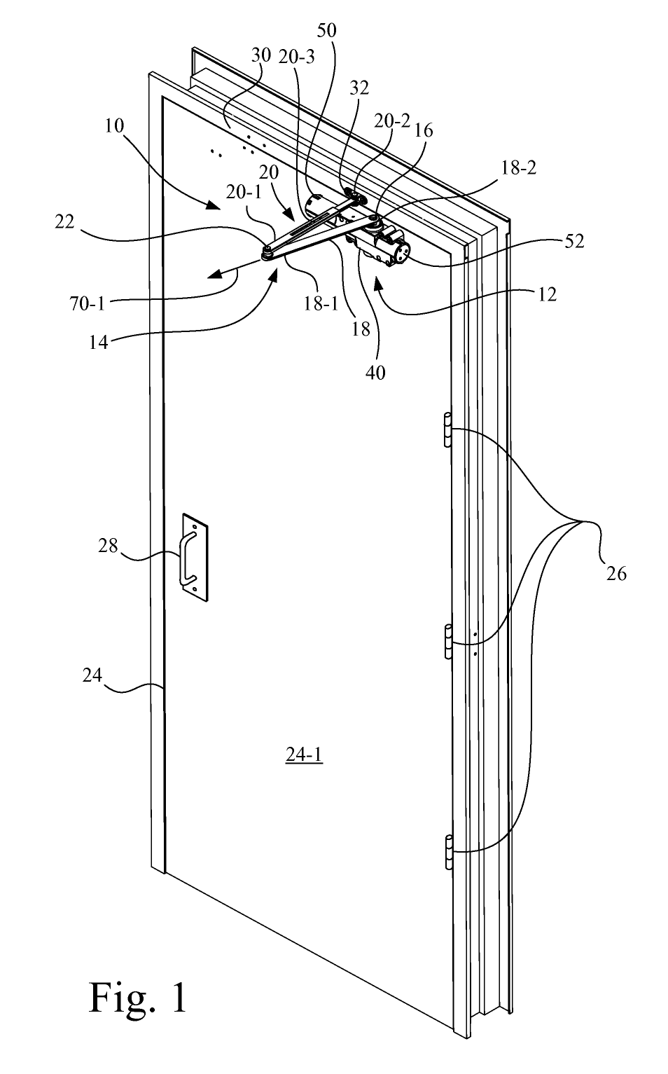

Referring now to the drawings and particularly to FIGS. 1-4, there is shown a door closer assembly 10 of the present invention, including a door closer 12 and a door closer arm assembly 14. Door closer 12 includes a rotatable pinion 16. Door closer arm assembly 14 is in the form of an articulating linkage that includes a main closer arm 18 and a secondary closer arm 20.

Main closer arm 18 and a secondary closer arm 20 are pivotally joined at respective ends 18-1, 20-1 at a pivot joint 22. Pivot joint 22 may be, for example, a pin/hole arrangement. A mounting end 18-2 of the main closer arm 18 is connected to pinion 16 of the door closer 12. Secondary closer arm 20 has a mounting end 20-2, and may have a length adjustment mechanism 20-3. Length adjustment mechanism 20-3 may be, for example, in the form of a pair of adjustable slide bars, as in the embodiment shown, or may be a threaded rod/nut, or turnbuckle, type of arrangement.

Referring to FIG. 1, door closer assembly 10 is configured as a regular (standard) mount on a pull-side 24-1 (sometimes also referred to as the hinge side) of a left-hand door 24 having hinges 26 and a door pull handle 28. Door pull handle 28 is representative of any handle structure mounted on the pull-side of the door, and may be a typical pull handle, as illustrated, or may be, for example, a doorknob, door lever, door push bar, etc. Mounting end 20-2 of secondary closer arm 20 is pivotally mounted to a door frame 30 via a pivot mount 32. Pivot mount 32 may include, for example, a pin/hole arrangement. Also, it is to be understood that, for convenience, pivot mount 32 is generally representative of any of the pivot mounting brackets/hardware structures that may be used for mounting the mounting end 20-2 of secondary closer arm 20, and it is to be understood that pivot mount 32 may have different configurations depending on whether pivot mount 32 is being used, for example, in a standard mount application or a parallel arm mount application.

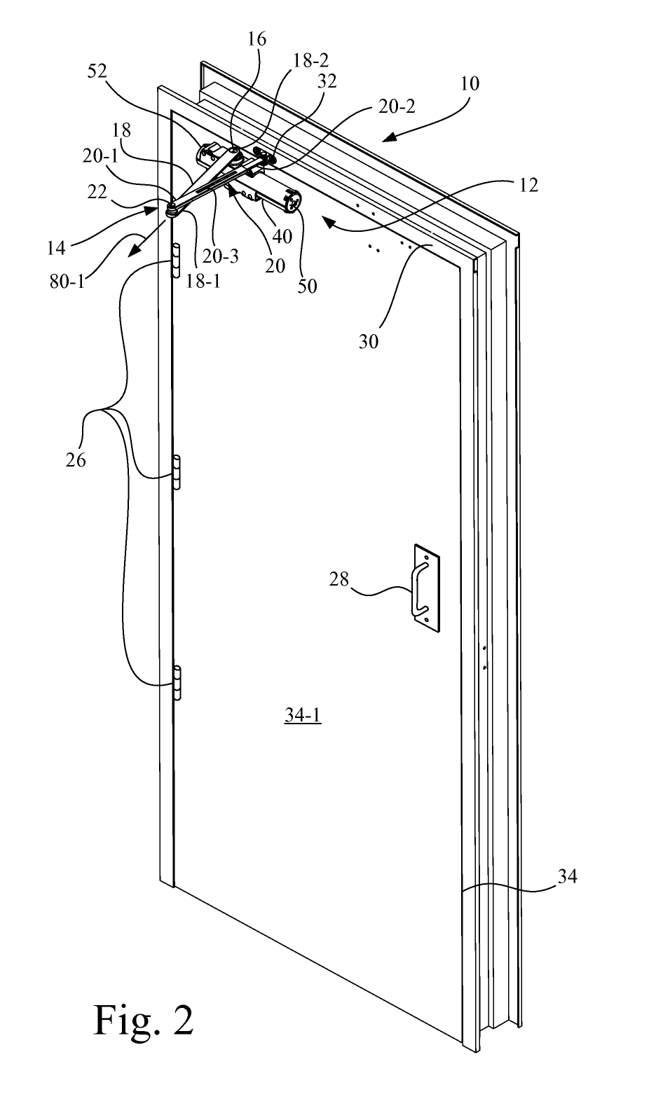

Referring to FIG. 2, door closer assembly 10 is configured as a regular (standard) mount on a pull-side 34-1 of a right-hand door 34 having hinges 26 and door pull handle 28. Mounting end 20-2 of secondary closer arm 20 is pivotally mounted to door frame 30 via pivot mount 32. In FIG. 2, door closer 12 is rotated end-to-end (180 degrees) from the mounting orientation on the left-hand door of FIG. 1. As such, main closer arm 18 is connected to the opposite end of pinion 16 in the regular mount right-hand door configuration of FIG. 2 in comparison to the regular mount left-hand door configuration of FIG. 1.

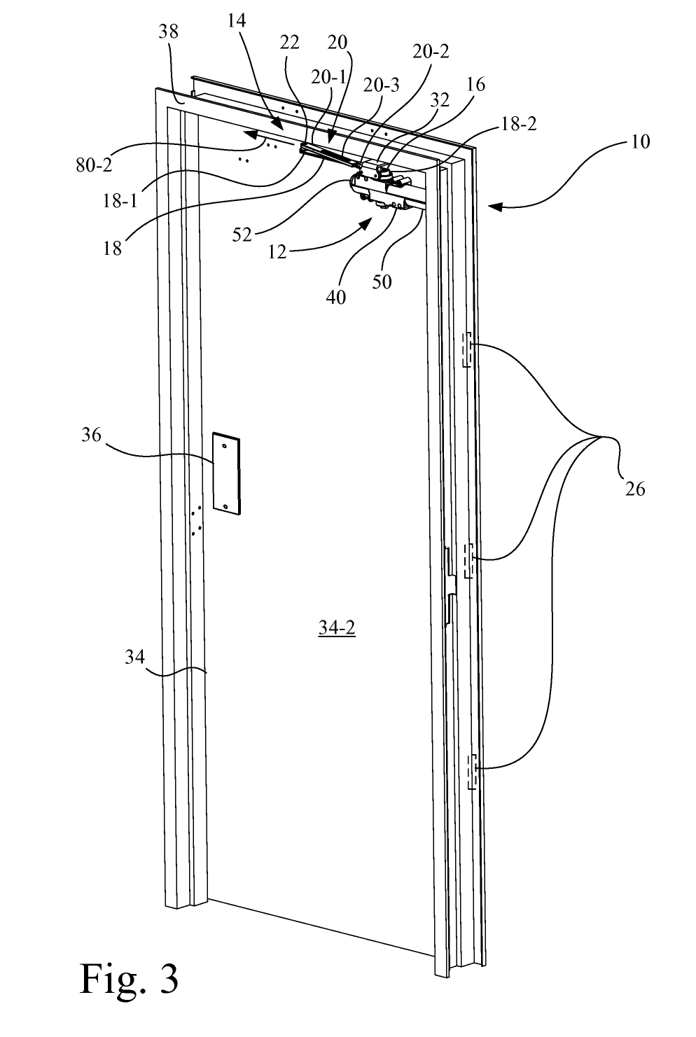

Referring to FIG. 3, door closer assembly 10 is configured as a parallel mount on a push-side 34-2 (sometimes also referred to as the stop side) of right-hand door 34 having hinges 26 and a door push plate 36. Door push plate 36 is representative of any push structure mounted on the push-side of the door, and may be a typical push plate, as illustrated, or may be, for example, a doorknob, door lever, door push bar, etc. Mounting end 20-2 of secondary closer arm 20 is pivotally mounted to door frame 38 via pivot mount 32.

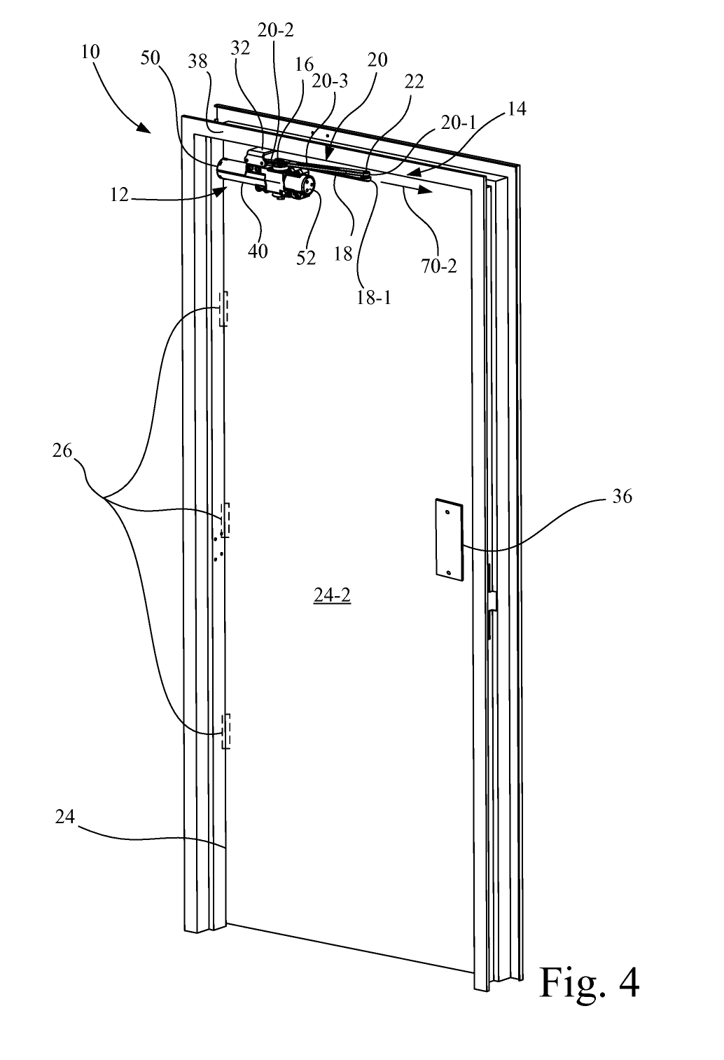

Referring to FIG. 4, door closer assembly 10 is configured as a parallel mount on push-side 24-2 of left-hand door 24 having hinges 26 and door push plate 36. Mounting end 20-2 of secondary closer arm 20 is pivotally mounted to door frame 38 via pivot mount 32. In FIG. 4, door closer 12 is rotated end-to-end (180 degrees) from the mounting orientation on the left-hand door of FIG. 3. As such, main closer arm 18 is connected to the opposite end of pinion 16 in the parallel mount left-hand door configuration of FIG. 4 in comparison to the parallel mount right-hand door configuration of FIG. 3.

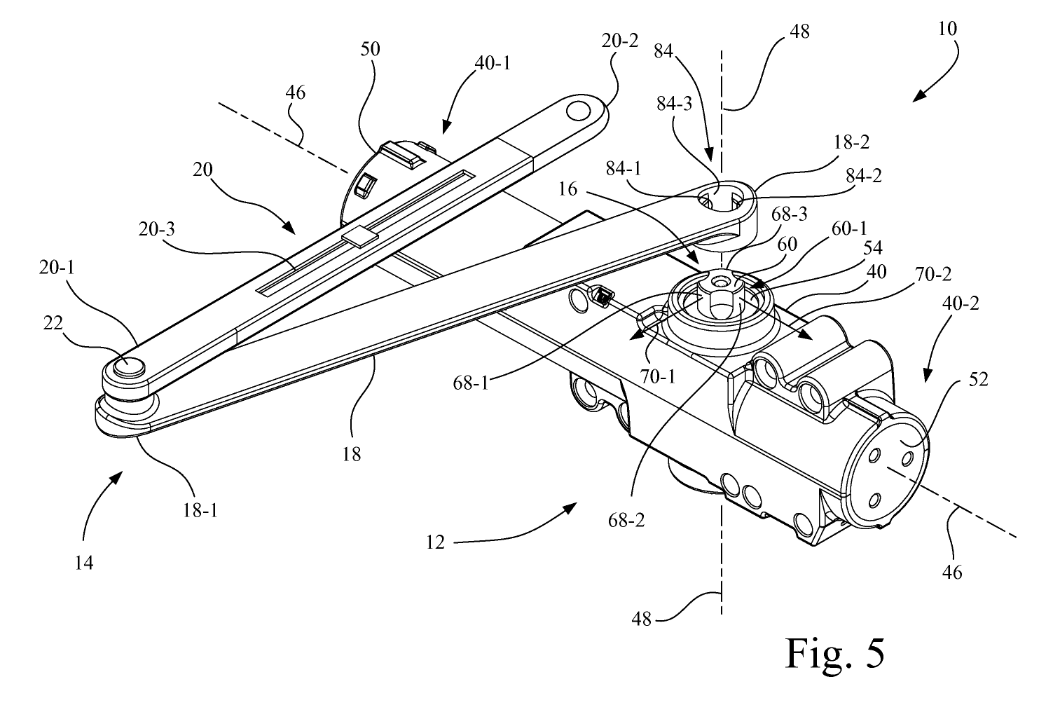

Referring also to FIGS. 5-7, door closer 12 includes a housing 40, a piston 42, a spring mechanism 44, and pinion 16.

Housing 40 has a first enclosed end 40-1, a second enclosed end 40-2, a longitudinal bore 40-3 and a pinion bore 40-4. The longitudinal bore 40-3 defines a longitudinal axis 46. Longitudinal bore 40-3 is configured to extend between the first enclosed end 40-1 and the second enclosed end 40-2. First enclosed end 40-1 includes a removable end cap 50, and second enclosed end 40-2 includes a removable end cap 52. More particularly, removable end cap 50 is threadably engaged with housing 40 at first enclosed end 40-1, and removable end cap 52 is threadably engaged with housing 40 at second enclosed end 40-2.

Pinion bore 40-4 defines a rotational axis 48 that is perpendicular to the longitudinal axis 46. Pinion bore 40-4 is configured to receive pinion 16. Pinion 16 is restrained in housing 40 by removable pinion retainer caps 54. Pinion 16 is rotatably supported within housing 40 by a pair of bearings, or bushings, 56.

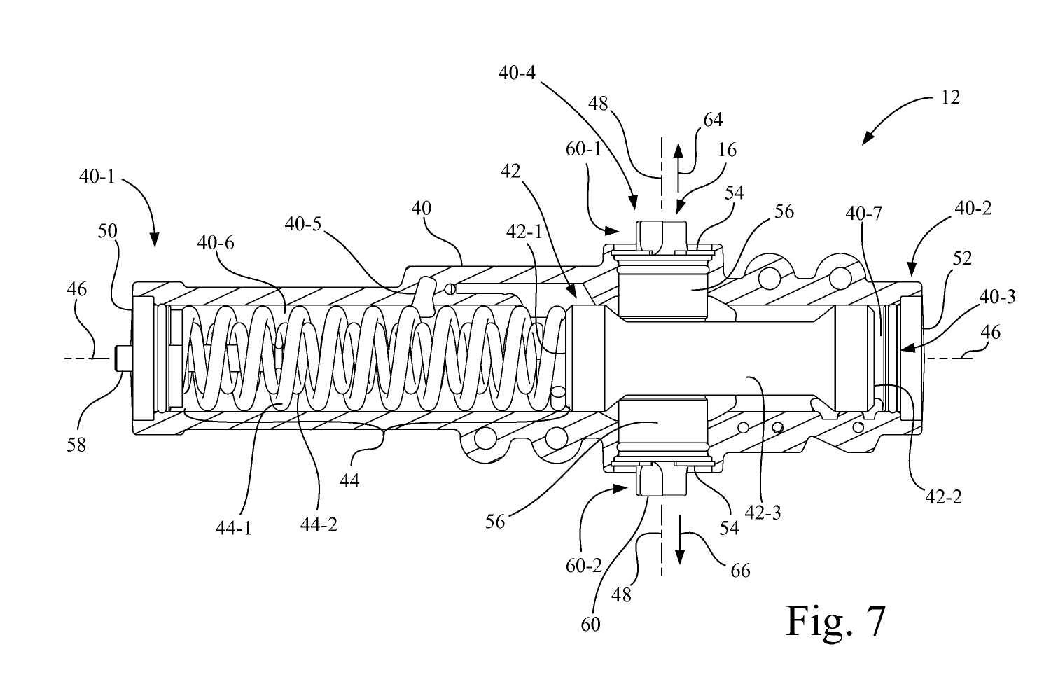

Referring particularly to FIG. 7, piston 42 is configured for insertion into longitudinal bore 40-3, and is configured for longitudinal translation along longitudinal axis 46 within longitudinal bore 40-3. When received in longitudinal bore 40-3, piston 42 divides longitudinal bore 40-3 into a spring chamber 40-6 and a reservoir chamber 40-7. Each of spring chamber 40-6 and reservoir chamber 40-7 will contain a variable amount of hydraulic fluid, e.g. oil.

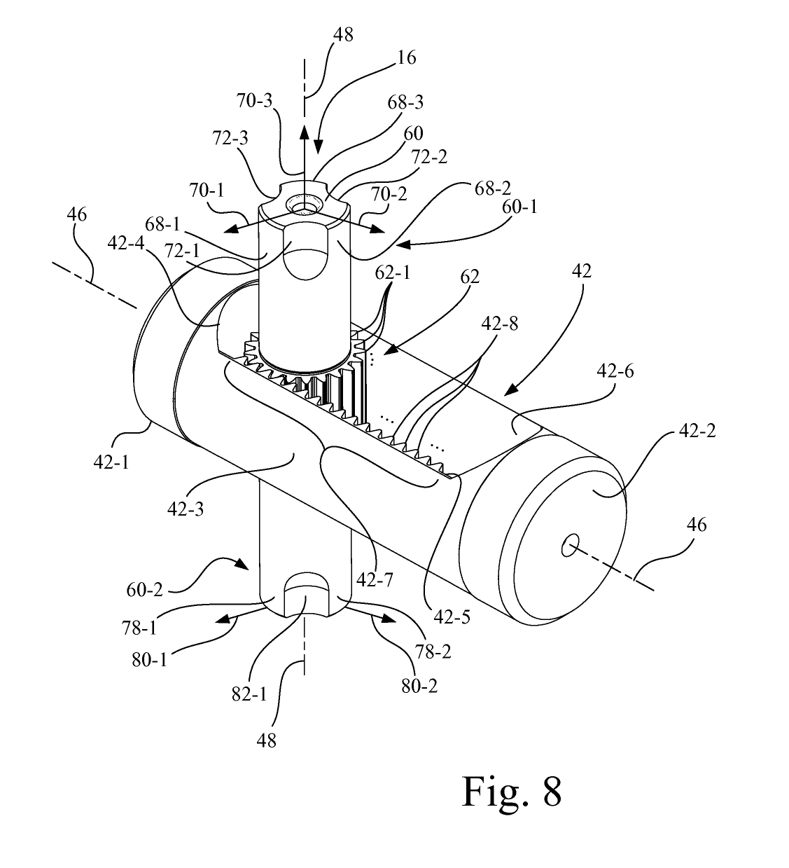

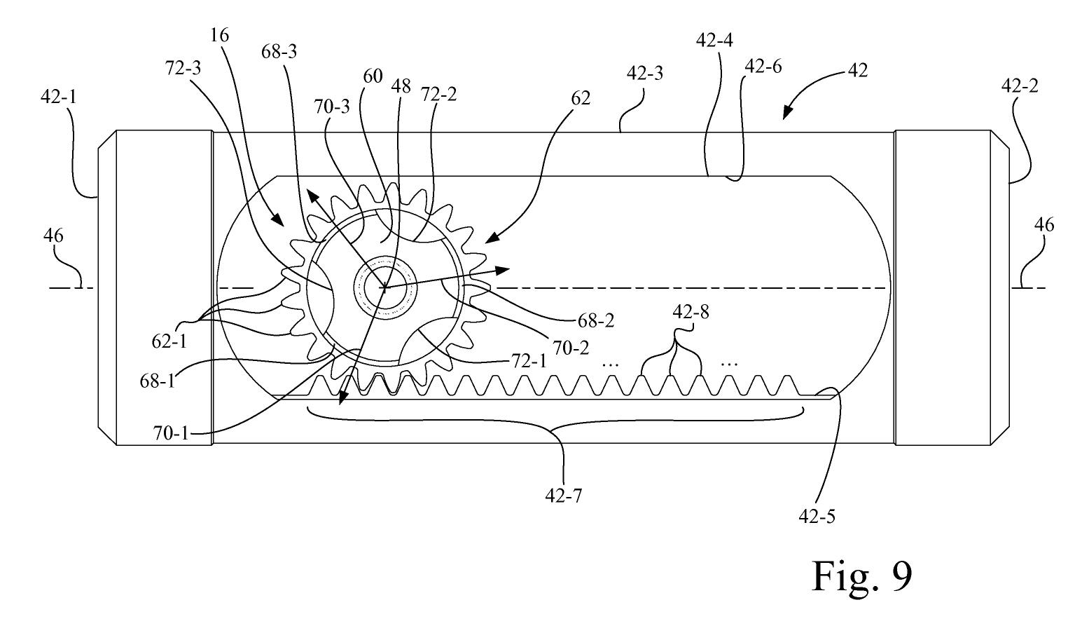

Referring also to FIGS. 8 and 9, piston 42 has a proximal end 42-1, a distal end 42-2, a body 42-3, and an elongate slotted opening 42-4. Body 42-3 extends between proximal end 42-1 and distal end 42-2. Proximal end 42-1 is positioned adjacent to spring chamber 40-6, and distal end 42-2 is positioned adjacent to reservoir chamber 40-7. Housing 40 also includes one or more hydraulic passages 40-5 that extend between spring chamber 40-6 and reservoir chamber 40-7. Hydraulic passages 40-5 facilitate a transfer of the hydraulic fluid between spring chamber 40-6 and reservoir chamber 40-7. Hydraulic passages 40-5 may include damping components (e.g., check valve, orifices, etc.) to facilitate a damped transfer of the hydraulic fluid.

Referring particularly to FIGS. 7-9, elongate slotted opening 42-4 of piston 42 extends vertically (in the orientation shown) through body 42-3 of piston 42 in a direction parallel to pinion bore 40-4, i.e., parallel to rotational axis 48. Elongate slotted opening 42-4 has two opposed longitudinal wall faces 42-5 and 42-6. Wall face 42-5 is configured as a rack gear 42-7 having a plurality of longitudinally spaced rack teeth 42-8.

Referring again to FIG. 7, spring mechanism 44 is interposed between first enclosed end 40-1 of the housing 40 and proximal end 42-1 of the piston 42. In particular, spring mechanism 44 is retained in longitudinal bore 40-3 of housing 40 by removable end cap 50. In the present embodiment, spring mechanism 44 includes a primary coil spring 44-1 and a secondary coil spring 44-2. However, spring mechanism 44 may be implemented using a single spring, or multiple springs. A spring tension adjustment rod 58 is threadably engaged with removable end cap 50 and is configured to adjust the spring pre-load of spring mechanism 44.

During a door opening, spring mechanism 44 is compressed to store energy. The compression is a result to the rotation of pinion 16, which in turn causes a linear translation of piston 42 in a direction toward first enclosed end 40-1 of housing 40 so as to compress spring mechanism 44. During door opening, hydraulic fluid is transferred via one or more of hydraulic passages 40-5 from spring chamber 40-6 to reservoir chamber 40-7 as a result of the movement of piston 42.

During a door closure, spring mechanism 44 decompresses to release the stored energy, and in turn causes a linear translation of piston 42 to rotate pinion 16. During door closure, hydraulic fluid is transferred via one or more of hydraulic passages 40-5 from reservoir chamber 40-7 to spring chamber 40-6 as a result of the movement of piston 42 by action of spring mechanism 44 in a direction toward second enclosed end 40-2 of housing 40. Hydraulic passages 40-5 may include damping components (e.g., check valve, orifices, etc.) to facilitate a damped transfer of the hydraulic fluid from reservoir chamber 40-7 to spring chamber 40-6 during door closure, so as to prevent a rapid closure (i.e., slamming) of the door.

Referring to FIGS. 8-12, pinion 16 has an elongate pinion shaft 60 and a pinion gear 62. Referring also to FIG. 7, pinion 16 is positioned in pinion bore 40-4 of the housing 40 to extend (vertically as shown) through the elongate slotted opening 42-4 of the piston 42 along rotational axis 48.

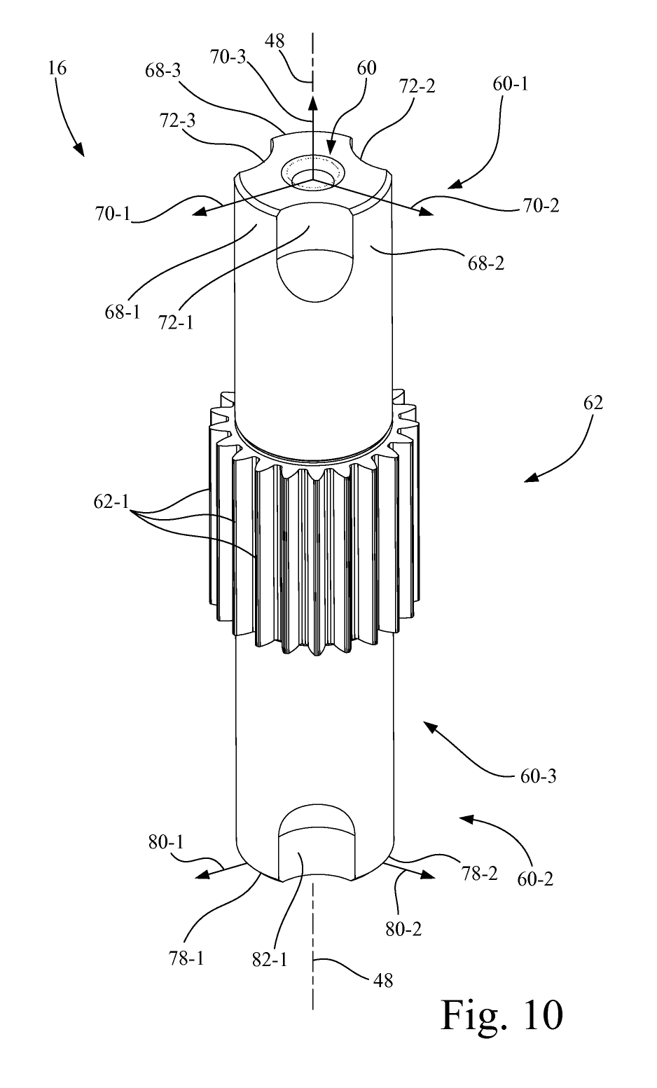

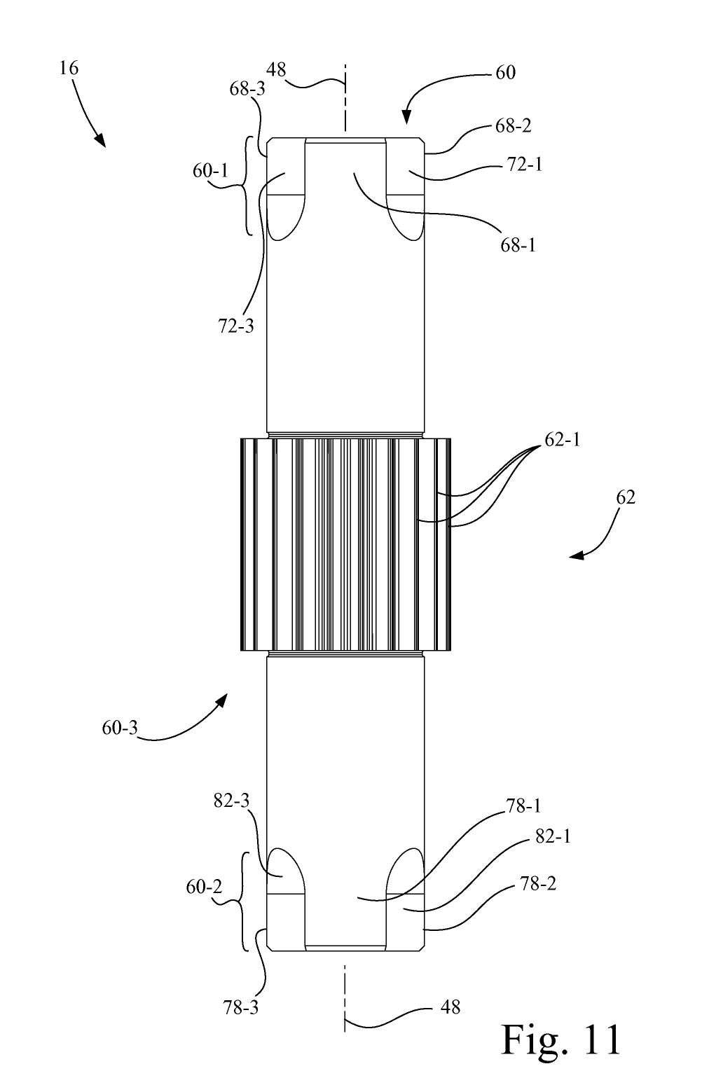

Referring particularly to FIGS. 10 and 11, pinion shaft 60 has a first tri-lobe end portion 60-1, a second tri-lobe end portion 60-2, and an intermediate portion 60-3 between the first tri-lobe end portion 60-1 and the second tri-lobe end portion 60-2. First tri-lobe end portion 60-1 and second tri-lobe end portion 60-2 may be formed with, or without, a shaft taper depending on the application. In other words, a circumference at a distal end of each of the first tri-lobe end portion 60-1 and the second tri-lobe end portion 60-2 is equal to (straight shaft) or less than (tapered) the circumference of intermediate portion 60-3 of the pinion shaft 60.

Referring also to FIG. 7, first tri-lobe end portion 60-1 extends outwardly from the housing 40 along the rotational axis 48 in a first direction 64, and second tri-lobe end portion 60-2 extends outwardly from the housing 40 along the rotational axis 48 in a second direction 66 opposite the first direction 64.

Referring to FIGS. 8-11, first tri-lobe end portion 60-1 has three lobes that are individually identified as lobe 68-1, lobe 68-2, and lobe 68-3. The three lobes 68-1, 68-2, 68-3 are arranged in an equilateral triangle configuration, i.e., having 120 degrees between the apexes of the triangle. Stated differently, each of lobe 68-1, lobe 68-2, and lobe 68-3 is circumferentially centered on a respective radius of three radii 70-1, 70-2, 70-3 of pinion shaft 60 that extend from the rotational axis 48, which are depicted in the drawings for convenience as radial projections. The three radii 70-1, 70-2, 70-3 (radial projections) are equally spaced at 120 degree increments around rotational axis 48. Each of first lobe 68-1, second lobe 68-2 and third lobe 68-3 has a convex arcuate extent that is circumferentially centered on a respective radius of the three radii 70-1, 70-2, 70-3 that extend from the rotational axis 48. Each adjacent pair of lobes 68-1, 68-2; 68-2, 68-3; 68-3, 68-1 is separated by a respective concave arcuate recess of three concave recesses 72-1, 72-2, 72-3.

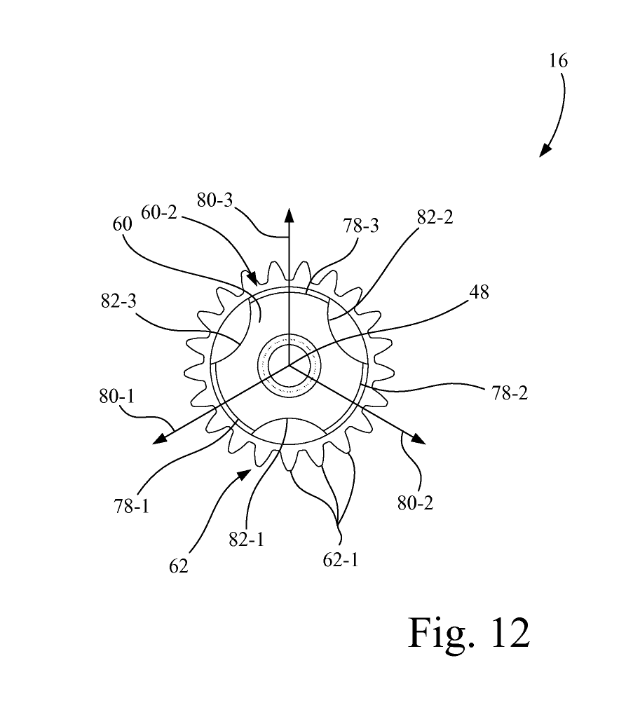

In the present embodiment, second tri-lobe end portion 60-2 is symmetrically identical to first tri-lobe end portion 60-1. Referring also to FIG. 12 with respect to FIGS. 10 and 11, second tri-lobe end portion 60-2 has three lobes that are individually identified as lobe 78-1, lobe 78-2, and lobe 78-3. The three lobes 78-1, 78-2, 78-3 are arranged in an equilateral triangle configuration, i.e., having 120 degrees between the apexes of the triangle. Each of lobe 78-1, lobe 78-2, and lobe 78-3 has a convex arcuate extent that is circumferentially centered on a respective radius of three radii 80-1, 80-2, 80-3 of pinion shaft 60 that extend from the rotational axis 48, which are depicted in the drawings for convenience as radial projections. The three radii 80-1, 80-2, 80-3 (radial projections) are equally spaced at 120 degree increments around rotational axis 48, and projection in the same directions as the three radii 70-1, 70-2, 70-3 such that the three radii 70-1, 70-2, 70-3 are respectively in rotational alignment about rotational axis 48 with the three radii 80-1, 80-2, 80-3, and in turn, the three lobes 68-1, 68-2, and 68-3 are respectively in rotational alignment about rotational axis 48 with lobes 78-1, 78-2, and 78-3. Each adjacent pair of lobes 78-1, 78-2; 78-2, 78-3; 78-3, 78-1 is separated by a respective concave arcuate recess of the three concave recesses 82-1, 82-2, 82-3.

As shown in FIGS. 8-12, pinion gear 62 extends radially outwardly from intermediate portion 60-3 of pinion shaft 60 between first tri-lobe end portion 60-1 and second tri-lobe end portion 60-2. In the present embodiment, pinion gear 62 is in the form of a spur gear. Pinion gear 62 has pinion teeth 62-1 that drivably engage rack teeth 42-8 of rack gear 42-7 of piston 42, as shown in FIG. 8. Pinion gear 62 has a number of pinion teeth 62-1 defined as a positive integer multiple of the number of lobes on either of first tri-lobe end portion 60-1 or second tri-lobe end portion 60-2, i.e., a positive integer multiple of three.

Also, referring to FIGS. 10 and 12, there is an equal number of pinion teeth 62-1 located between each adjacent pair of radii, with reference to either the radii 70-1, 70-2, 70-3 of first tri-lobe end portion 60-1 or the radii 80-1, 80-2, 80-3 of second tri-lobe end portion 60-2 of pinion shaft 60. For example, in the present exemplary embodiment, there is a total of 21 pinion teeth 62-1, and thus there are seven pinion teeth 62-1 between each adjacent pair of radii 70-1, 70-2; 70-2, 70-3; 70-3, 70-1 of first tri-lobe end portion 60-1.

Referring also to FIG. 5, each of first tri-lobe end portion 60-1 and second tri-lobe end portion 60-2 is configured to be received in driving engagement into a corresponding tri-lobe opening 84 at mounting end 18-2 of main closer arm 18. In particular, tri-lobe opening 84 has three lobe channels, individually identified as lobe channel 84-1, lobe channel 84-2, and lobe channel 84-3. As such, first tri-lobe end portion 60-1 accommodates three mounting positions of main closer arm 18, corresponding to the three radii 70-1, 70-2, 70-3 (radial projections) of first tri-lobe end portion 60-1 of pinion shaft 60. Likewise, second tri-lobe end portion 60-2 also accommodates three mounting positions of main closer arm 18, corresponding to the three radii 80-1, 80-2, 80-3 (radial projections) of second tri-lobe end portion 60-2 of pinion shaft 60.

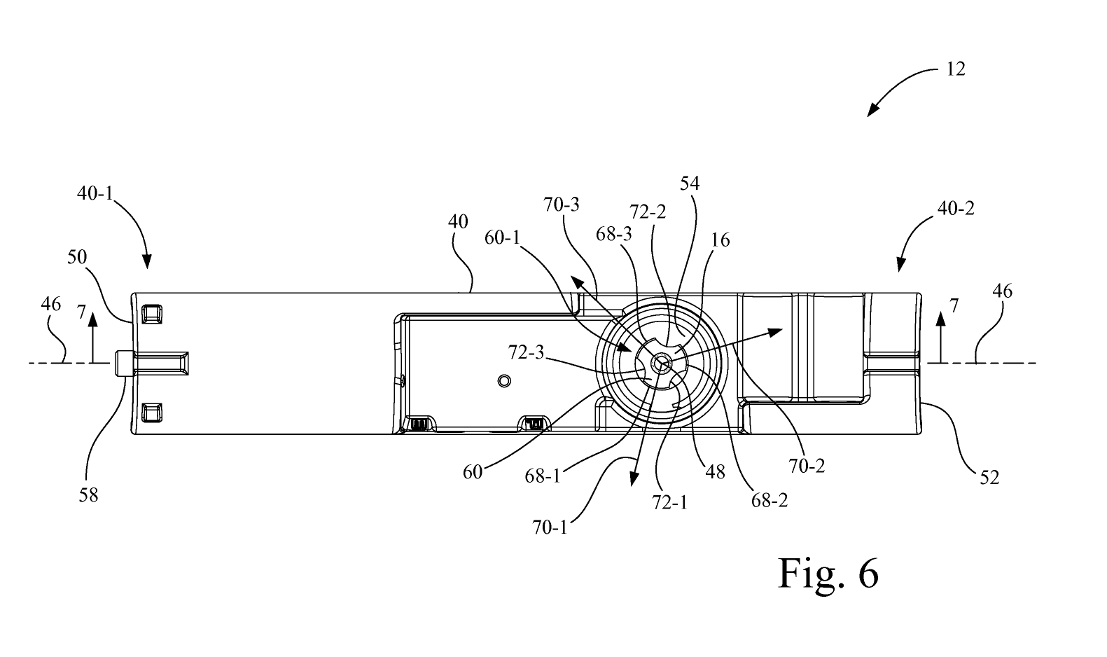

Referring again particularly to FIG. 1 in relation to FIGS. 5-9, door closer assembly 10 is configured as a regular (standard) mount on pull-side 24-1 of left-hand door 24. In a regular (standard) mount of door closer assembly 10, the spring end (first enclosed end 40-1 having removable end cap 50) of housing 40 extends away from the hinge end (see hinges 26) of left-hand door 24. As such, for left-hand door 24, the housing 40 is oriented such that first tri-lobe end portion 60-1 of pinion shaft 60 is projecting upwardly to receive main closer arm 18. Also, in a regular (standard) mount of door closer assembly 10, the main closer arm 18 is oriented to be generally perpendicular (90 degrees+15 degrees) to pull-side 24-1 of left-hand door 24. Thus, main closer arm 18 is positioned on first tri-lobe end portion 60-1 of pinion shaft 60 such that main closer arm 18 extends along radial projection 70-1. Accordingly, and with reference to FIGS. 5 and 6, only an orientation of main closer arm 18 that extends along the radius (radial projection) 70-1 will satisfy the installation criteria, since the other radial projections 70-2, 70-3 along which main closer arm 18 could be installed are 120 degrees removed from the correct position.

Referring again particularly to FIG. 2, in relation to FIGS. 5, 8 and 10-12, door closer assembly 10 is configured as a regular (standard) mount on pull-side 34-1 of right-hand door 34. Again, in a regular (standard) mount of door closer assembly 10, the spring end (first enclosed end 40-1 having removable end cap 50) of housing 40 extends away from the hinge end (see hinges 26) of right-hand door 34. As such, for right-hand door 34, the housing 40 of door closer 12 is rotated 180 degrees from that of the left-hand door configuration of FIG. 1, and as such second tri-lobe end portion 60-2 of pinion shaft 60 (see also FIG. 7) is projecting upwardly to receive main closer arm 18. Again, in a regular (standard) mount of door closer assembly 10, the main closer arm 18 is oriented to be generally perpendicular (90 degrees+15 degrees) to pull-side 34-1 of right-hand door 34. Thus, main closer arm 18 is positioned on second tri-lobe end portion 60-2 of pinion shaft 60 such that main closer arm 18 extends along radial projection 80-1. Accordingly, and with reference to FIGS. 8 and 10-12, only an orientation of main closer arm 18 that extends along the radius (radial projection) 80-1 will satisfy the installation criteria, since the other radial projections 80-2, 80-3 along which main closer arm 18 could be installed are 120 degrees removed from the correct position.

Referring again particularly to FIG. 3, door closer assembly 10 is configured as a parallel mount on push-side 34-2 of right-hand door 34. In a parallel mount of door closer assembly 10, the spring end (first enclosed end 40-1 having removable end cap 50) of housing 40 extends toward the hinge end (see hinges 26) of right-hand door 34. As such, for right-hand door 34, the housing 40 is oriented such that second tri-lobe end portion 60-2 of pinion shaft 60 (see also FIG. 7) is projecting upwardly to receive main closer arm 18. Also, in a parallel mount, main closer arm 18 is generally parallel (0 degrees+15 degrees) to the surface of push-side 34-2 of right-hand door 34. Accordingly, and with reference to FIGS. 8 and 10-12, only an orientation of main closer arm 18 that extends along the radius (radial projection) 80-2 will satisfy the installation criteria, since the other radial projections 80-1, 80-3 along which main closer arm 18 could be installed are 120 degrees removed from the correct position. Thus, main closer arm 18 is positioned on second tri-lobe end portion 60-2 such that main closer arm 18 extends along radial projection 80-2.

Referring again to FIG. 4 in relation to FIGS. 5-9, door closer assembly 10 is configured as a parallel mount on push-side 24-2 of left-hand door 24. In a parallel mount of door closer assembly 10, the spring end (first enclosed end 40-1 having removable end cap 50) of housing 40 extends toward the hinge end (see hinges 26) of left-hand door 24. As such, for left-hand door 24, the housing 40 of door closer 12 is rotated 180 degrees from that of the right-hand door configuration of FIG. 3, and as such first tri-lobe end portion 60-1 of pinion shaft 60 is projecting upwardly to receive main closer arm 18. In a parallel mount, main closer arm 18 is generally parallel (0 degrees+15 degrees) to the surface of push-side 24-2 of left-hand door 24. Accordingly, and with reference to FIGS. 5, 6, 8 and 9, only an orientation of main closer arm 18 that extends along the radius (radial projection) 70-2 will satisfy the installation criteria, since the other radial projections 70-1 and 70-3 along which main closer arm 18 could be installed are 120 degrees removed from the correct position. Thus, main closer arm 18 is positioned on first tri-lobe end portion 60-1 such that main closer arm 18 extends along radial projection 70-2.

Thus, advantageously, with door closer assembly 10 of the present invention, for either orientation of housing 40 to accommodate a left-hand door 24 or a right-hand door 34, there are only three possible mounting orientations of main closer arm 18 on pinion 16. As such, there is one correct orientation of main closer arm 18 for any given mounting type, but unlike the prior art, there are only two possible incorrect orientations. Also, as described above, having a lobe spacing on-center of 120 degrees around the rotational axis 48 of pinion 16 helps clearly identify the correct orientation relative to the incorrect orientations, for a particular mounting type. This simplifies installation and significantly reduces or eliminates potential assembly errors.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A door closer assembly, comprising:
a housing having a first enclosed end, a second enclosed end, a longitudinal bore and a pinion bore, the longitudinal bore defining a longitudinal axis and the longitudinal bore configured to extend between the first enclosed end and the second enclosed end, and the pinion bore defining a rotational axis that is perpendicular to the longitudinal axis;
a piston configured for insertion into the longitudinal bore, the piston having a proximal end, a distal end, and a body extending between the proximal end and the distal end, the piston having an elongate slotted opening extending through the body in a direction parallel to the pinion bore, the elongate slotted opening having a wall face configured as a rack gear having a plurality of longitudinally spaced rack teeth;
a pinion having an elongate pinion shaft and a pinion gear, the elongate pinion shaft including a first tri-lobe end portion, and the pinion gear extending radially outwardly from the elongate pinion shaft, the pinion gear having a number of pinion teeth defined as a positive integer multiple of three, wherein three corresponds to the number of lobes of the first tri-lobe end portion,
the pinion positioned in the pinion bore of the housing to extend through the elongate slotted opening of the piston along the rotational axis, the pinion gear being drivably engaged with the rack gear of the piston, the first tri-lobe end portion extending outwardly from the housing along the rotational axis in a first direction; and
a closer arm having a tri-lobe opening configured to receive the first tri-lobe end portion in driving engagement.

2. The door closer assembly of claim 1, wherein the first tri-lobe end portion includes a first lobe, a second lobe and a third lobe circumferentially centered on a respective radius of three radii that extend from the rotational axis, the three radii being equally spaced at 120 degree increments around the rotational axis.

3. The door closer assembly of claim 2, wherein each of the first lobe, the second lobe and the third lobe has a convex arcuate extent that is circumferentially centered on a respective radius of the three radii that extend from the rotational axis, and wherein each adjacent pair of lobes of the first lobe, the second lobe and the third lobe is separated by a respective concave arcuate recess of three concave recesses.

4. The door closer assembly of claim 2, wherein an equal number of pinion teeth are located between each adjacent pair of radii of the three radii.

5. The door closer assembly of claim 1, wherein the pinion further includes a second tri-lobe end portion extending outwardly from the housing along the rotational axis in a second direction opposite the first direction, wherein a configuration of the first tri-lobe end portion and the second tri-lobe end portion is identical, and the tri-lobe opening of the closer arm configured to receive one of the first tri-lobe end portion and the second tri-lobe end portion in driving engagement.

6. The door closer assembly of claim 5, wherein a circumference at a distal end of each of the first tri-lobe end portion and the second tri-lobe end portion is equal to or less than the circumference of an intermediate portion of the elongate pinion shaft.

7. The door closer assembly of claim 5, wherein each of the first tri-lobe end portion and the second tri-lobe end portion includes a first lobe, a second lobe and a third lobe, and wherein each of the first lobe, the second lobe and the third lobe is circumferentially centered on a respective radius of three radii that extend from the rotational axis, the three radii being equally spaced at 120 degree increments around the rotational axis.

8. The door closer assembly of claim 5, wherein each of the first tri-lobe end portion and the second tri-lobe end portion includes a first lobe, a second lobe and a third lobe, and wherein each of the first lobe, the second lobe and the third lobe has a convex arcuate extent that is circumferentially centered on a respective radius of three radii that extend from the rotational axis, and wherein each adjacent pair of lobes of the first lobe, the second lobe and the third lobe is separated by a respective concave arcuate recess of three concave recesses.

9. The door closer assembly of claim 8, wherein an equal number of pinion teeth are located between each adjacent pair of radii of the three radii.

10. The door closer assembly of claim 8, wherein a circumference at a distal end of each of the first tri-lobe end portion and the second tri-lobe end portion is equal to or less than the circumference of an intermediate portion of the pinion shaft.

11. A door closer assembly, comprising:
a door closer arm assembly configured as an articulating arm having a main closer arm and a secondary closer arm, the main closer arm being pivotally joined to the secondary closer arm, the main closer arm having a first mounting end and the secondary closer arm having a second mounting end, the first mounting end of the main closer arm having a tri-lobe opening; and
a door closer, including:
a housing having a first enclosed end, a second enclosed end, a longitudinal bore and a pinion bore, the longitudinal bore defining a longitudinal axis and the longitudinal bore configured to extend between the first enclosed end and the second enclosed end, and the pinion bore defining a rotational axis that is perpendicular to the longitudinal axis;
a piston having a proximal end, a distal end, and a body extending between the proximal end and the distal end, the piston configured for insertion into the longitudinal bore to divide the longitudinal bore into a spring chamber and a reservoir chamber, with the distal end being positioned adjacent to the reservoir chamber,
the piston having a elongate slotted opening extending through the body of the piston in a direction parallel to the pinion bore, the elongate slotted opening having two opposed longitudinal wall faces, with one wall face of the two opposed longitudinal wall faces being configured as a rack gear having a plurality of longitudinally spaced rack teeth;
at least one damped hydraulic passage extending within the housing between the reservoir chamber and the spring chamber;
a spring mechanism interposed between the first enclosed end of the housing and the proximal end of the piston;
a pinion having an elongate pinion shaft and a pinion gear, the elongate pinion shaft having a first tri-lobe end portion, a second tri-lobe end portion, and an intermediate portion between the first tri-lobe end portion and the second tri-lobe end portion, the pinion gear extending radially outwardly from the intermediate portion between the first tri-lobe end portion and the second tri-lobe end portion, the pinion gear having a number of pinion teeth defined as a positive integer multiple of three, wherein three corresponds to the number of lobes of each of the first tri-lobe end portion and the second tri-lobe end portion,
the pinion positioned in the pinion bore of the housing to extend through the elongate slotted opening of the piston along the rotational axis, the pinion gear being drivably engaged with the rack gear of the piston, the first tri-lobe end portion extending outwardly from the housing along the rotational axis in a first direction, and the second tri-lobe end portion extending outwardly from the housing along the rotational axis in a second direction opposite the first direction,
the tri-lobe opening of the main closer arm being configured to receive one of the first tri-lobe end portion and the second tri-lobe end portion in driving engagement.

12. The door closer assembly of claim 11, wherein the first tri-lobe end portion includes a first lobe, a second lobe and a third lobe circumferentially centered on a respective radius of three radii that extend from the rotational axis, the three radii being equally spaced at 120 degree increments around the rotational axis.

13. The door closer assembly of claim 12, wherein each of the first lobe, the second lobe and the third lobe has a convex arcuate extent that is circumferentially centered on a respective radius of three radii that extend from the rotational axis, and wherein each adjacent pair of lobes of the first lobe, the second lobe and the third lobe is separated by a respective concave arcuate recess of three concave recesses.

14. The door closer assembly of claim 13, wherein an equal number of pinion teeth are located between each adjacent pair of radii of the three radii.

15. The door closer assembly of claim 13, wherein a configuration of the first tri-lobe end portion and the second tri-lobe end portion is identical.

16. The door closer assembly of claim 11, wherein a circumference at a distal end of each of the first tri-lobe end portion and the second tri-lobe end portion is equal to or less than the circumference of the intermediate portion of the elongate pinion shaft.

17. The door closer assembly of claim 11, wherein each of the first tri-lobe end portion and the second tri-lobe end portion includes a first lobe, a second lobe and a third lobe, and wherein each of the first lobe, the second lobe and the third lobe is circumferentially centered on a respective radius of three radii that extend from the rotational axis, the three radii being equally spaced at 120 degree increments around the rotational axis.

18. The door closer assembly of claim 11, wherein each of the first tri-lobe end portion and the second tri-lobe end portion includes a first lobe, a second lobe and a third lobe, and wherein each of the first lobe, the second lobe and the third lobe has a convex arcuate extent that is circumferentially centered on a respective radius of three radii that extend from the rotational axis, and wherein each adjacent pair of lobes of the first lobe, the second lobe and the third lobe is separated by a respective concave arcuate recess of three concave recesses.

19. The door closer assembly of claim 18, wherein an equal number of pinion teeth are located between each adjacent pair of radii of the three radii.

20. The door closer assembly of claim 18, wherein a circumference at a distal end of each of the first tri-lobe end portion and the second tri-lobe end portion is equal to or less than the circumference of the intermediate portion of the pinion shaft.

21. A pinion for a door closer configured to accommodate both a regular mount and a parallel mount, comprising:
an elongate pinion shaft having a rotational axis, a first tri-lobe end portion, a second tri-lobe end portion, and an intermediate portion between the first tri-lobe end portion and the second tri-lobe end portion,
each of the first tri-lobe end portion and the second tri-lobe end portion having a first lobe, a second lobe and a third lobe, wherein each of the first lobe, the second lobe and the third lobe has a convex arcuate extent that is circumferentially centered on a respective radius of three radii that extend from the rotational axis, and wherein each adjacent pair of lobes of the first lobe, the second lobe and the third lobe is separated by a respective concave arcuate recess of three concave recesses; and
a pinion gear extending radially outwardly from the elongate pinion shaft, the pinion gear having a number of pinion teeth defined as a positive integer multiple of three, wherein three corresponds to the number of lobes of each of the first tri-lobe end portion and the second tri-lobe end portion.

22. The pinion of claim 21, wherein the three radii are equally spaced at 120 degree increments around the rotational axis.

23. The pinion of claim 22, wherein an equal number of pinion teeth are located between each adjacent pair of radii of the three radii.

24. The pinion of claim 23, wherein the equal number of pinion teeth is seven, for a total of 21 pinion teeth.

25. A door closer, comprising:
a housing having a first enclosed end, a second enclosed end, a longitudinal bore and a pinion bore, the longitudinal bore defining a longitudinal axis and the longitudinal bore configured to extend between the first enclosed end and the second enclosed end, and the pinion bore defining a rotational axis that is perpendicular to the longitudinal axis;
a piston configured for insertion into the longitudinal bore, the piston having a proximal end, a distal end, and a body extending between the proximal end and the distal end, the piston having an elongate slotted opening extending through the body in a direction parallel to the pinion bore, the elongate slotted opening having a wall face configured as a rack gear having a plurality of longitudinally spaced rack teeth; and
a pinion having an elongate pinion shaft and a pinion gear, the elongate pinion shaft including a first tri-lobe end portion, and the pinion gear extending radially outwardly from the elongate pinion shaft, the pinion gear having a number of pinion teeth defined as a positive integer multiple of three, wherein three corresponds to the number of lobes of the first tri-lobe end portion,
the pinion positioned in the pinion bore of the housing to extend through the elongate slotted opening of the piston along the rotational axis, the pinion gear being drivably engaged with the rack gear of the piston, the first tri-lobe end portion extending outwardly from the housing along the rotational axis in a first direction.

26. The door closer of claim 25, wherein the first tri-lobe end portion includes a first lobe, a second lobe and a third lobe circumferentially centered on a respective radius of three radii that extend from the rotational axis, the three radii being equally spaced at 120 degree increments around the rotational axis.

27. The door closer of claim 26, wherein each of the first lobe, the second lobe and the third lobe has a convex arcuate extent that is circumferentially centered on a respective radius of the three radii that extend from the rotational axis, and wherein each adjacent pair of lobes of the first lobe, the second lobe and the third lobe is separated by a respective concave arcuate recess of three concave recesses.

28. The door closer of claim 26, wherein an equal number of pinion teeth are located between each adjacent pair of radii of the three radii.

29. The door closer of claim 25, wherein the pinion further includes a second tri-lobe end portion extending outwardly from the housing along the rotational axis in a second direction opposite the first direction, wherein a configuration of the first tri-lobe end portion and the second tri-lobe end portion is identical, and the tri-lobe opening of the closer arm configured to receive one of the first tri-lobe end portion and the second tri-lobe end portion in driving engagement.

30. The door closer of claim 29, wherein a circumference at a distal end of each of the first tri-lobe end portion and the second tri-lobe end portion is equal to or less than the circumference of an intermediate portion of the elongate pinion shaft.

31. The door closer of claim 29, wherein each of the first tri-lobe end portion and the second tri-lobe end portion includes a first lobe, a second lobe and a third lobe, and wherein each of the first lobe, the second lobe and the third lobe is circumferentially centered on a respective radius of three radii that extend from the rotational axis, the three radii being equally spaced at 120 degree increments around the rotational axis.

32. The door closer of claim 29, wherein each of the first tri-lobe end portion and the second tri-lobe end portion includes a first lobe, a second lobe and a third lobe, and wherein each of the first lobe, the second lobe and the third lobe has a convex arcuate extent that is circumferentially centered on a respective radius of three radii that extend from the rotational axis, and wherein each adjacent pair of lobes of the first lobe, the second lobe and the third lobe is separated by a respective concave arcuate recess of three concave recesses.

33. The door closer of claim 32, wherein an equal number of pinion teeth are located between each adjacent pair of radii of the three radii.

34. The door closer of claim 32, wherein a circumference at a distal end of each of the first tri-lobe end portion and the second tri-lobe end portion is equal to or less than the circumference of an intermediate portion of the pinion shaft.

35. The door closer of claim 25, wherein the first tri-lobe end portion includes a first lobe, a second lobe and a third lobe arranged in an equilateral triangle configuration.

36. The door closer of claim 35, wherein the pinion further includes a second tri-lobe end portion extending outwardly from the housing along the rotational axis in a second direction opposite the first direction, the second tri-lobe end portion includes a fourth lobe, a fifth lobe and a sixth lobe arranged in an equilateral triangle configuration.

37. The door closer of claim 36, comprising a main closer arm having a tri-lobe opening configured to receive either of the first tri-lobe end portion in driving engagement or the second tri-lobe end portion in driving engagement.

38. The door closer of claim 36, wherein the second tri-lobe end portion is configured to be in rotational alignment with the first tri-lobe end portion.
